(19) United States
(12) Patent Application Publication
(10) Pub. No.: US 2013/0100567 A1
(43) Pub. Date: Apr. 25, 2013

(54) POWER DISTRIBUTION APPARATUS FOR SEPARATE ELECTRICAL OVER CURRENT AND SHORT CIRCUIT PROTECTION

(71) Applicants: GREGORY A. REYNOLDS, SARATOGA, CA (US); CHARLES H. REYNOLDS, SAN JOSE, CA (US)

(72) Inventors: GREGORY A. REYNOLDS, SARATOGA, CA (US); CHARLES H. REYNOLDS, SAN JOSE, CA (US)

(73) Assignee: CYBER SWITCHING, INC., SAN JOSE, CA (US)

(21) Appl. No.: 13/279,303

(22) Filed: Oct. 23, 2011

(51) Int. Cl. H02H 9/02

(52) U.S. Cl. 361/93.1

(57) ABSTRACT

A system for protecting electrical power distribution circuits and loads electrically connected thereto comprises a circuit breaker or fuse in series with an over current protection device, for example a virtual circuit breaker. The circuit breaker or fuse provides protection against a short circuit condition, and the virtual circuit breaker provides against excess current. Separating the two protection means enables providing a higher current allowance for loads connected to outlets on a branch circuit.

### CROSS REFERENCES TO RELATED APPLICATIONS

This application is related to commonly-owned U.S. patent application Ser. No. 11/437,959 titled CURRENT PROTECTION APPARATUS AND METHOD filed 10 May 2006 by Gregory A. Reynolds et al, now U.S. Pat. No. 7,672,104 issued 2 Mar. 2010, and to U.S. patent application Ser. No. 11/437,958 titled CURRENT PROTECTION APPARATUS AND METHOD filed 10 May 2006 by Gregory A. Reynolds et al, now U.S. Pat. No. 7,630,186 issued 8 Dec. 2009, both are incorporated herein in their entirety.

### FIELD OF THE INVENTION

The present invention relates generally to power distribution systems, and more particularly to the protection power distribution systems provide to a load.

### BACKGROUND

In the prior art, power is distributed from a grid connection point typically denominated as a “panel board” to an individual load via a series of connection/distribution points (branch circuits). Each branch circuit may provide power to an end load device or to another branch circuit. For example a grid connection point may connect to a plurality of panel boards, and some of the panel boards may in turn connect to another panel board, which may connect to another panel board and so on until a panel board not connected to another downstream panel board is connected. Any of such panels may provide power to branch circuits containing a single load or multiple loads as well as to another panel board further downstream.

A panel board comprises means for power distribution, and each distribution point, whether to a singular load or to another distribution device, such as a power distribution unit (“PDU”) or another panel board, includes protection devices to guard against an over current (excess current) and against a short circuit condition. Building codes such as the National Electric Code and Underwriters Laboratories, Inc., standards dictate the amount of current protection a branch circuit must provide its downstream loads. A panel board is required to provide a certain value of current protection to another panel board connected downstream. In the prior art the protection required is essentially a percentage of the current of all the loads downstream from the instant panel board.

Physical circuit breakers are large, taking up valuable space in a typical PDU, and are expensive. They limit the amount of current available in a branch circuit because they are sized to the capacity of the outlets used. The arrangement of a panel board supplying power to another panel board, etc, can lead to the requirement of very large upstream circuit breakers. An upstream circuit breaker must be sized (current rating) high enough to accommodate the downstream currents. Downstream branches to a terminal outlet must have their own circuit breaker because code requires that the terminal outlet have both short circuit and over current protection. Protection against a short circuit and protection against an over current situation require different capabilities by a protection device. A short circuit must be sensed (and interrupted) very fast else damage or fire result at or near the shorting point. An over current situation can be sensed and protected against more slowly, and the circuit breaker should not trip from a noise spike (nuisance tripping). Due to the requirement for an upstream circuit breaker to be rated according to its downstream loads and terminal outlets, the downstream power available is limited. For example, a PDU with six 20 A rated outlets would be required by code to have an upstream circuit breaker of 20 A. This means that the six outlets can only draw a combined current of 20 A. This limitation effectively reduces the available current to each outlet. If each outlet draws 3.33 A, then the circuit is at the limit of the branch and below the current value limit of each outlet.

### SUMMARY

According to the various aspects of the inventive concept, virtual circuit breakers (“VCB”) are included in a PDU or panel(s) downstream of a circuit breaker. The circuit breaker provides short circuit protection, in that they are designed, manufactured, and tested for short circuit capability. However the downstream PDU or panel may have individual outlets which limit the size of the upstream circuit breaker according to the outlet rating. If each outlet is protected by a virtual circuit breaker then a larger rated upstream circuit breaker could be used. In the example above, the outlets could be protected by a 30 A upstream circuit breaker thereby allowing 5 A per outlet instead of only 3.33 A per outlet.

### BRIEF DESCRIPTION OF THE DRAWINGS

The accompanying drawings, which are incorporated herein and constitute part of this specification, illustrate exemplary aspects of the invention, and, together with the general description given above and the detailed description given below, serve to explain features of the invention.

FIG. 1 is an example of an arrangement of a circuit breaker protecting downstream loads from a short circuit.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

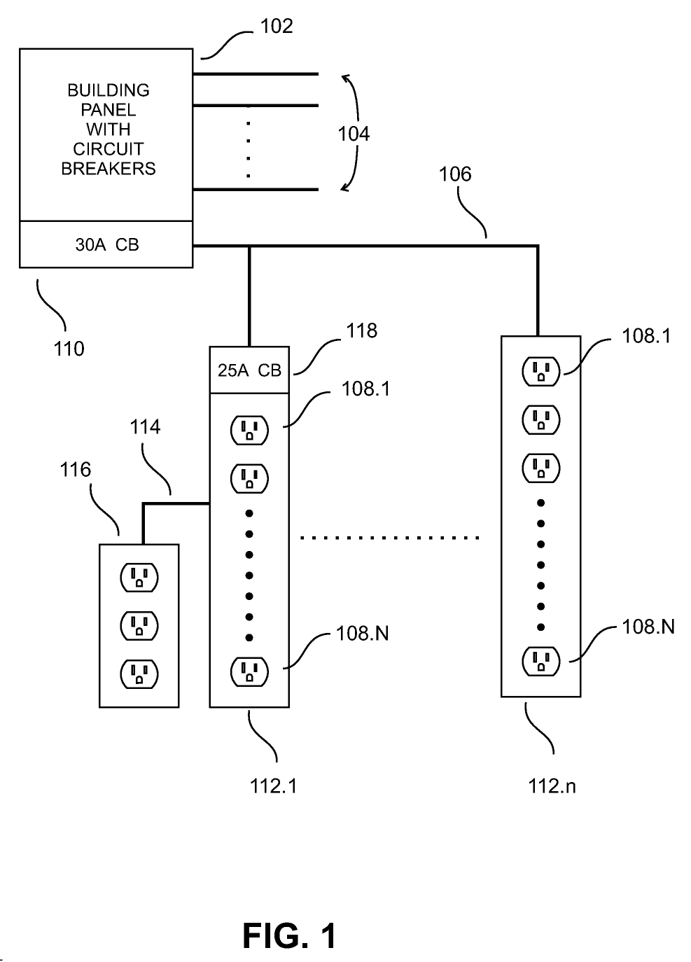

Referring to FIG. 1, a building panel 102 provides electrical power to various downstream branch circuits 104, including to a specific branch 106 selected to further detail aspects of the inventive concept. Each branch 104 has a dedicated corresponding circuit breaker (not shown) in the panel 102, wherein the current specification of each circuit breaker corresponds to the allowable current value of the branch circuit. These branches do not embody the inventive concept disclosed herein. Note that, particularly in older systems, a fuse may be used instead of a circuit breaker. Hereinafter we will refer to circuit breakers, but “fuses” may be used just as well. An example of a circuit breaker is a UL-489 device, though any circuit breaker may be used in practicing the invention.

An exemplary branch 106 may be connected to a circuit breaker 110 in the panel 102. For the purpose of illustration, the circuit breaker 110 is shown as being a 30 amp circuit breaker, though any value may be used in practicing the invention. Loads on this branch 106 comprise a number of power panels or PDUs 112. 1 through 112.n, referred to collectively or individually herein after as simply PDU 112. Each PDU 112 comprises an arbitrary number of outlets 108.n. A given PDU 112 may also provide power to an arbitrary number of downstream panels or PDUs 116 on a power line 114. Each outlet 108.n, whether a terminating outlet or an electrical connection to another downstream panel or PDU 116, may be protected from over current by a virtual circuit breaker (“VCB”) as disclosed in the U.S. Pat. No. 7,672,104 or 7,630,186. Each VCB may be individually and independently configured for a current limit appropriate for its own associated outlet 108, or downstream panel 116, wherein the sum of the various outlet currents is limited only by the current value limit of the upstream circuit breaker 110, thereby providing a partitioning of protection.

As disclosed, the upstream circuit breaker 110 provides short circuit protection for all downstream loads. The circuit breaker 110 also provides total overall current protection if the sum of actual current values on line 106 exceeds the protection specification of the circuit breaker 110. Protection against over current on a load by load basis may be provided by the individual VCBs embodied within each PDU 112. A given PDU 112 may also comprise an optional series connected circuit breaker 118 to provide short circuit protection and VCBs at each outlet 108 to provide over current protection.

Circuit breakers are physically large. Circuit breakers typically physically fit into a power panel 102 but are undesirable in a PDU 112 in that a PDU 112 is physically smaller than a power panel 102. Using VCBs therefore provides the flexibility of protecting each outlet at its rated current, and may lower total electrical system cost by enabling higher downstream currents, thereby replacing some power panels 102 with smaller, less expensive power distribution units 112 or small panels.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A circuit protection system comprising a short circuit protection device electrically connected in series with an over current device.

2. The system of claim 1, wherein the short circuit protection device is a circuit breaker.

3. The system of claim 1, wherein the short circuit protection device is a fuse.

4. The system of claim 1, wherein the over current device is a virtual circuit breaker.
